(19) United States
(12) Patent Application Publication
(10) Pub. No.: US 2009/0153014 A1
(43) Pub. Date: Jun. 18, 2009

(54) ELECTRON-EMITTING DEVICE, ELECTRON SOURCE, AND IMAGE DISPLAY APPARATUS

(75) Inventors: Kazushi Nomura, Sagamihara-shi (JP); Ryoji Fujiwara, Chigasaki-shi (JP); Michiyo Nishimura, Sagamihara-shi (JP); Yoji Teramoto, Ebina-shi (JP); Shunsuke Murakami, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/331,244

(22) Filed: Dec. 9, 2008

(30) Foreign Application Priority Data
Dec. 14, 2007 (JP) 2007-323177

(51) Int. Cl. H01J 1/00

(52) U.S. Cl. 313/311

(57) ABSTRACT

An electron-emitting device according to the present invention is an electron-emitting device having a cathode electrode, an insulating film provided on the cathode electrode, and a dipole layer provided on the insulating film, wherein the dipole layer is formed by terminating the insulating film with an NH group. An electron source according to the present invention has a plurality of the electron-emitting devices. An image display apparatus according to the present invention has the electron source and a light emitting member that emits light by irradiation with electrons.

### BACKGROUND OF THE INVENTION

1. Field of the Invention

The present invention relates to an electron-emitting device, an electron source, and an image display apparatus.

2. Description of the Related Art

Electron-emitting devices include a field emission type (FE type) electron-emitting device and a surface conduction type electron-emitting device.

The FE type electron-emitting device is a device that applies a voltage between a cathode electrode (and an electron-emitting film arranged thereon) and a gate electrode to elicit electrons from the cathode electrode (or the electron-emitting film) by the voltage (electric field) into a vacuum. Thus, an operating electric field greatly depends on a work function of the cathode electrode (electron-emitting film) to be used and a shape thereof. It is generally believed that a cathode electrode (electron-emitting film) with a small work function needs to be selected.

Conventionally, an electron-emitting device capable of emitting electrons in a low electric field is desired and also an emitted electron beam that focuses is desired (Naturally, an easy manufacturing process is also desired).

Diamond whose surface is terminated with hydrogen is a typical material having a negative electron affinity. An electron-emitting device using the surface of diamond having a negative electron affinity as an electron-emitting surface is disclosed in Japanese Patent Application Laid-Open (JP-A) No. 9-199001, the specification of U.S. Pat. No. 5,283,501, the specification of U.S. Pat. No. 5,180,951, and V. V. Zhinov, J. Liu et al., “Environmental effect on the electron emission from diamond surfaces”, J. Vac. Sci. Technol., B16 (3), May/June 1998, pp. 1188-1193.

However, it is difficult to form a film of diamond having a uniform thickness in a large area, producing a problem in a process of manufacturing an electron-emitting device. It is also difficult to make surface roughness of a diamond film smaller and thus, a problem of emitted electrons being broadened arises. Thus, electron-emitting devices using a thin film of diamond-like carbon or amorphous carbon are under development, but there is a problem that such devices are hard to drive due to a high electric field for electron emission.

A technique to form a dipole layer on the surface of an electron-emitting film is disclosed in Japanese Patent Application Laid-Open (JP-A) No. 2005-26209 as a conventional art in view of the above problems. With a dipole layer formed on the surface of an electron-emitting film, it becomes possible for the electron-emitting device to emit electrons in a low electric field.

An electron-emitting device having the dipole layer is considered to have an effect according to a magnitude of polarization of the dipole layer.

### SUMMARY OF THE INVENTION

Thus, an object of the present invention is to provide a field emission type electron-emitting device that realizes electron emission in a lower electric field, can emit electrons at a low voltage with a high degree of efficiency, and whose manufacturing process is easy, an electron source, and an image display apparatus.

To achieve the above object, an electron-emitting device according to the present invention is an electron-emitting device having a cathode electrode, an insulating film provided on the cathode electrode, and a dipole layer provided on the insulating film, wherein the dipole layer is formed by terminating the insulating film with an NH group.

Also, an electron-emitting device according to the present invention is an electron-emitting device having a cathode electrode and an insulating film provided on the cathode electrode and formed from material having carbon as a main component, wherein a surface of the insulating film is terminated with an NH group.

Also, an electron source according to the present invention includes a plurality of the electron-emitting devices.

Also, an image display apparatus according to the present invention includes the electron source and a light emitting member that emits light by irradiation with electrons.

According to the present invention, a field emission type electron-emitting device that realizes electron emission in a lower electric field, can emit electrons at a low voltage with a high degree of efficiency, and whose manufacturing process is easy, an electron source, and an image display apparatus can be provided.

Further features of the present invention will become apparent from the following description of exemplary embodiments with reference to attached drawings.

### BRIEF DESCRIPTION OF THE DRAWINGS

FIG. 1 is a diagram exemplifying a method of manufacturing an electron-emitting device according to the present embodiment;

FIG. 2 is a diagram exemplifying the method of manufacturing the electron-emitting device according to the present embodiment;

FIG. 3 is a diagram exemplifying an apparatus for driving the electron-emitting device according to the present embodiment;

FIG. 4 is a diagram showing a surface treatment apparatus for terminating a surface of the electron-emitting device according to the present embodiment with an NH group;

FIG. 5 is a diagram exemplifying an electron source, which is an applied example of the electron-emitting device according to the present embodiment;

FIG. 6 is a diagram exemplifying an image display apparatus, which is an applied example of the electron-emitting device according to the present embodiment;

FIGS. 7A and 7B are diagrams showing a driving principle of the electron-emitting device according to the present embodiment; and

FIG. 8 is a diagram showing a schematic diagram of a dipole layer in the electron-emitting device according to the present embodiment.

### DESCRIPTION OF THE EMBODIMENTS

A preferred embodiment of the present invention will exemplarily be described below in detail with reference to drawings. However, if not specifically mentioned, sizes, materials, shapes, relative configuration thereof and the like of components described in the embodiment do not limit the scope of the present invention to those described only.

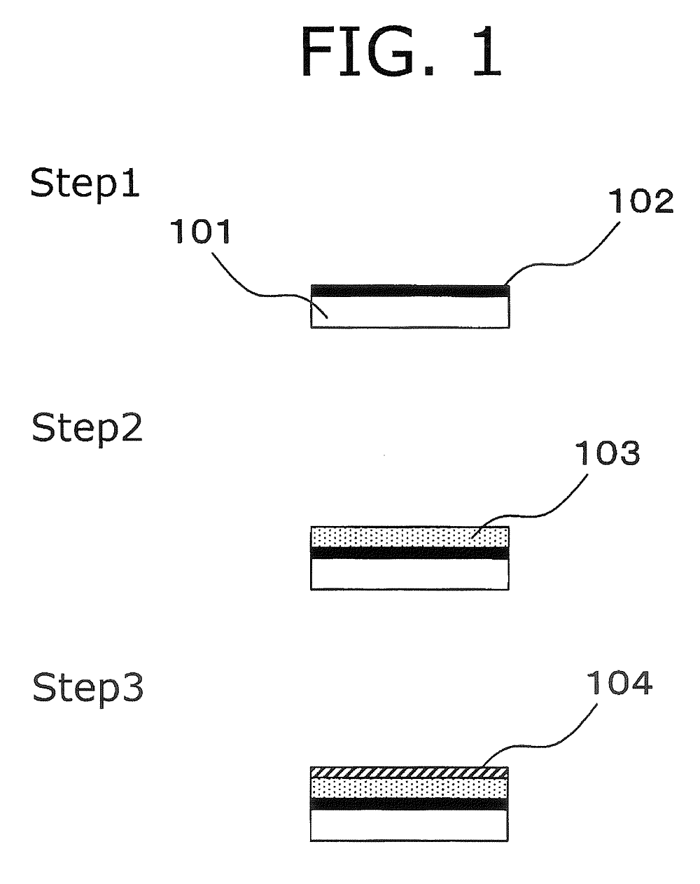

FIG. 1 is a diagram exemplifying a method of manufacturing an electron-emitting device according to the present embodiment. In FIG. 1, Step 1 is a step to form a cathode electrode 102 on a substrate 101. Step 2 is a step to form an insulating film 103 (electron-emitting film; electron emission material) on the cathode electrode 102. Step 3 is a step to terminate the surface of the insulating film 103 with an NH group. Each step will be described in detail later.

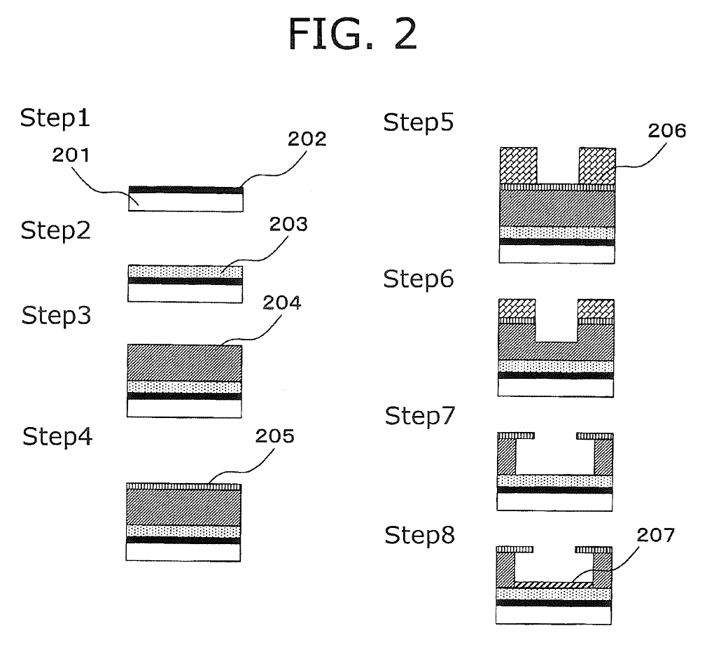

FIG. 2 is a diagram exemplifying the method of manufacturing the electron-emitting device according to the present embodiment. In FIG. 2, Step 1 is a step to form a cathode electrode 202 on a substrate 201. Step 2 is a step to form an insulating film 203 (electron-emitting film; electron-emitting material) on the cathode electrode 202. Step 3 is a step to form an insulating layer 204 on the insulating film 203. Step 4 is a step to form a gate electrode 205 on the insulating layer 204. Step 5 is a step to perform patterning by a photo resist on the gate electrode 205. Step 6 is a step to remove a portion of the gate electrode 205 and a portion of the insulating layer 204 by dry etching. Step 7 is a step to further remove a portion of the insulating layer 204 by wet etching to form an opening of the gate electrode 205 and the insulating layer 204. A portion or all of the insulating film 203 is exposed in the opening by this step. Step 8 is a step to terminate a portion or all of the surface of the insulating film 203 with an NH group. Each step will be described in detail later.

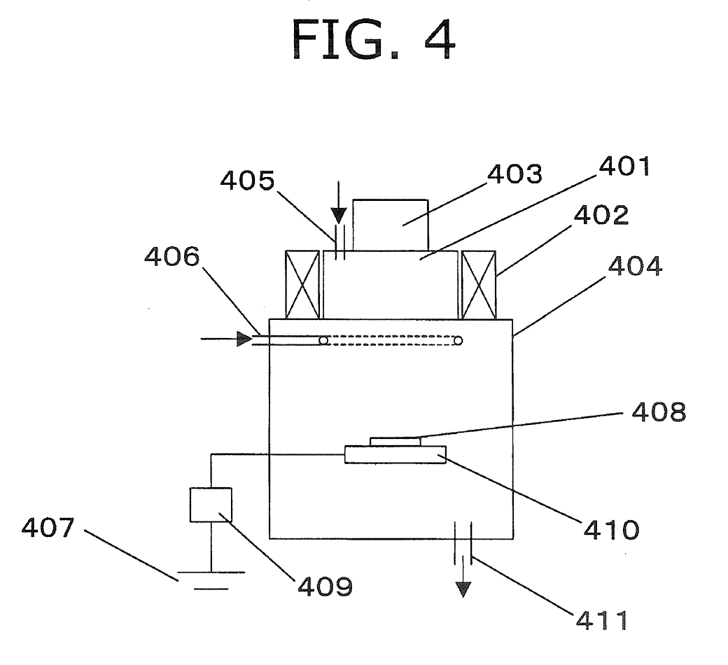

FIG. 4 is a diagram showing a surface treatment apparatus for terminating the surface of the electron-emitting device according to the present embodiment with an NH group. In FIG. 4, reference numeral 401 is a plasma generation chamber, reference numeral 402 is a magnetic coil, reference numeral 403 is a microwave inlet, and reference numeral 404 is a sample chamber. Reference numeral 405 is a treatment gas inlet A, reference numeral 406 is a treatment gas inlet B, reference numeral 407 is a DC power supply A, reference numeral 408 is a surface treatment sample, reference numeral 409 is a DC power supply B, reference numeral 410 is a substrate heating heater, and reference numeral 411 is an outlet.

A method of manufacturing an electron-emitting device will be described below in detail using FIG. 1.

(Step 1)

First, the cathode electrode 102 is formed on a substrate whose surface is sufficiently cleaned. The substrate (the substrate 101) may be selected from quartz glass, glass whose impurity content such as Na is reduced, soda lime glass, a layered body obtained by forming SiO₂ on a silicon substrate or the like by a sputtering method, and an insulating substrate of ceramic such as alumina. Roughness of the surface of the substrate 101 is preferably smaller than 1/10 of a thickness of the substrate 101 in RMS (Root Mean Square) notation.

The cathode electrode 102 generally has conductivity and is formed by general vacuum film formation technique such as the evaporation method and sputtering method, or photolithography technique. Material of the cathode electrode 102 is suitably selected from metals, alloys and the like. Metals to be used include, for example, Be, Mg, Ti, Zr, Hf, V, Nb, Ta, Mo, W, Al, Cu, Ni, Cr, Au, Pt, and Pd, and alloys to be used include those alloys generated by these metals. The thickness of the cathode electrode 102 is set in the range of several tens of nm to several mm and preferably in the range of several hundreds of nm to several μm. Roughness of the surface of the cathode electrode 102 is preferably smaller than 1/10 of the thickness of the cathode electrode 102 in RMS notation. More specifically, roughness of the surface of the cathode electrode 102 is preferably 1 nm or less in RMS notation. Also, the surface of the cathode electrode 102 and that of the substrate 101 are preferably parallel to each other.

(Step 2)

Next, the insulating film 103 is formed on the cathode electrode. The insulating film 103 is formed by general vacuum film formation technique such as the evaporation method and sputtering method, or photolithography technique. The material of the insulating film 103 is preferably a material having carbon as a main component such as carbon and carbon compounds, but need not be limited to materials having carbon as a main component. The insulating film 103 may contain both carbon and carbon compounds. The insulating film 103 preferably has conductive particles dispersed and located therein or contains conductive particles. Metallic particles are preferably used as conductive particles. The size of conductive particles is set in the range of 1 nm to 10 nm and preferably set to about several nm. Materials of conductive particles to be used include metals such as Be, Mg, Mn, Ti, Zr, Hf, V, Nb, Ta, Mo, W, Al, Cu, Ni, Cr, Co, Fe, Ni, Au, Pt, and Pd, or alloys generated by using these metals. The material having carbon as a main component is suitably selected, for example, from diamond-like carbon and amorphous carbon. These are preferable because they contain sp³ carbon. The thickness of the insulating film 103 is set in the range of 20 nm or less and preferably set in the range of 10 nm or less. Roughness of the surface of the insulating film 103 is preferably smaller than 1/10 of the thickness of the insulating film 103 in RMS notation. If metal is dispersed inside the insulating film 103, the thickness of the insulating film 103 is defined to be the smallest value of values obtained by subtracting the thickness of the metal from the overall thickness.

(Step 3)

Next, the surface of the insulating film 103 is terminated with an NH group. The method of terminating with an NH group will be described using FIG. 4. The apparatus in FIG. 4 is a surface treatment apparatus using ECR plasma. As shown in FIG. 4, there is a plasma generation chamber over the sample chamber. A treatment gas is introduced into the plasma generation chamber, a magnetic field of magnetic flux density 875 Gauss, which is an ECR condition, is applied, and a microwave is introduced into the generation chamber to generate plasma. Generation of the plasma is considered to result from ionization of the treatment gas. The surface of the insulating film 103 is terminated with ions (radicals) generated by the ionization. In the apparatus in FIG. 4, the distribution of magnetic field of a magnetic coil is a divergent magnetic field in which the magnetic field becomes weaker as the magnetic field comes closer to the sample chamber.

Plasma can be suitably selected from high-frequency plasma, remote plasma, and microwave plasma. The treatment gas inlet A and the treatment gas inlet B are used to introduce a treatment gas. In the present embodiment, the treatment gas is suitably selected so that both hydrogen atoms and nitrogen atoms are contained such as a gas mixture of hydrogen and nitrogen and that of nitrogen and a hydrocarbon-based gas. Gases containing hydrogen atoms or nitrogen atoms include, for example, N₂, NH₄, H₂, CH₄, C₂H₄, and C₂H₂. If a treatment gas contains hydrogen atoms and nitrogen atoms, the treatment gas may not be a gas mixture. The treatment gas may be diluted by an inert gas. With the treatment gas containing both hydrogen atoms and nitrogen atoms, the surface of the insulating film 103 is terminated with an NH group.

The sample (device) may be heated by the substrate heating heater 410. The surface of the insulating film 103 can be terminated with an NH group only by heating the device in a treatment gas.

A dipole layer 104 is formed on the insulating film by the termination treatment.

An electron-emitting device can be produced by the above steps.

The method of manufacturing an electron-emitting device will be described below in detail using FIG. 2.

(Step 1)

First, the cathode electrode 202 is formed on a substrate whose surface is sufficiently cleaned. The substrate (the substrate 201) may be selected from quartz glass, glass whose impurity content such as Na is reduced, soda lime glass, a layered body obtained by forming SiO₂ on a silicon substrate or the like by a sputtering method, and an insulating substrate of ceramic such as alumina. Roughness of the surface of the substrate 201 is preferably smaller than 1/10 of a thickness of the substrate 201 in RMS (Root Mean Square) notation.

The cathode electrode 202 generally has conductivity and is formed by general vacuum film formation technique such as the evaporation method and sputtering method, or photolithography technique. Material of the cathode electrode 202 is suitably selected from metals, alloys and the like. Metals to be used include, for example, Be, Mg, Ti, Zr, Hf, V, Nb, Ta, Mo, W, Al, Cu, Ni, Cr, Au, Pt, and Pd, and alloys to be used include those alloys generated by these metals. The thickness of the cathode electrode 202 is set in the range of several tens of nm to several mm and preferably in the range of several hundreds of nm to several μm. Roughness of the surface of the cathode electrode 202 is preferably smaller than 1/10 of the thickness of the cathode electrode 202 in RMS notation. More specifically, roughness of the surface of the cathode electrode 202 is preferably 1 nm or less in RMS notation. Also, the surface of the cathode electrode 202 and that of the substrate 201 are preferably parallel to each other.

(Step 2)

Next, the insulating film 203 is formed on the cathode electrode. The insulating film 203 is formed by general vacuum film formation technique such as the evaporation method and sputtering method, or photolithography technique. The material of the insulating film 203 is preferably a material having carbon as a main component such as carbon and carbon compounds, but need not be limited to materials having carbon as a main component. The insulating film 203 may contain both carbon and carbon compounds. The insulating film 203 preferably has conductive particles dispersed and located therein or contains conductive particles. Metallic particles are preferably used as conductive particles. The size of the conductive particles is set in the range of 1 nm to 10 nm and preferably set to about several nm. Materials of conductive particles to be used include metals such as Be, Mg, Mn, Ti, Zr, Hf, V, Nb, Ta, Mo, W, Al, Cu, Ni, Cr, Co, Fe, Ni, Au, Pt, and Pd, or alloys generated by using these metals. The material having carbon as a main component is suitably selected, for example, from diamond-like carbon and amorphous carbon. These are preferable because they contain sp³ carbon. The thickness of the insulating film 203 is set in the range of 20 nm or less and preferably set in the range of 10 nm or less. Roughness of the surface of the insulating film 203 is preferably smaller than 1/10 of the thickness of the insulating film 203 in RMS notation. If metal is dispersed inside the insulating film 203, the thickness of the insulating film 203 is defined to be the smallest value of values obtained by subtracting the thickness of the metal from the overall thickness.

(Step 3)

Next, the insulating layer 204 is deposited. The insulating layer 204 is formed by a general vacuum film formation method such as the sputtering method, the CVD method, or the vacuum evaporation method. The thickness of the insulating layer 204 is set in the range of several nm to several μm and preferably selected from the range of 10 nm to 100 nm. The material of the insulating layer 204 is preferably a material with high voltage tightness capable of withstanding a high electric field such as SiO₂, SiN, Al₂O₃, CaF, and undoped diamond.

(Step 4)

Next, the gate electrode 205 is deposited on the insulating layer 204. The gate electrode 205 has, like the cathode electrode 202, conductivity and is formed by general vacuum film formation technique such as the evaporation method and sputtering method, or photolithography technique. Material of the gate electrode 205 is suitably selected from metals or the like. Metals to be used include, for example, Be, Mg, Ti, Zr, Hf, V, Nb, Ta, Mo, W, Al, Cu, Ni, Cr, Au, Pt, and Pd, and alloys to be used include those alloys generated by these metals. The thickness of the gate electrode 205 is set in the range of several nm to several tens of μm and preferably in the range of several tens of nm to several μm.

(Step 5)

Next, a mask pattern 206 is formed by photolithography technique.

(Step 6)

Next, the mask pattern 206 is used as a mask to remove a portion of the gate electrode 205 and a portion of the insulating layer 204 by drying etching.

(Step 7)

Next, a portion of the insulating layer 204 is further removed by wet etching. It is preferable to perform treatment by the wet etching by using a solvent that makes an etching rate of the insulating layer 204 higher than that of the gate electrode 205 and the insulating film 203 and also does not degrade the insulating film 203.

(Step 8)

Next, the surface of the insulating film 203 is terminated with an NH group. The method of terminating with an NH group will be described using FIG. 4. The apparatus in FIG. 4 is a surface treatment apparatus using ECR plasma. As shown in FIG. 4, there is a plasma generation chamber over the sample chamber. A treatment gas is introduced into the plasma generation chamber, a magnetic field of magnetic flux density 875 Gauss, which is an ECR condition, is applied, and a microwave is introduced into the generation chamber to generate plasma. Generation of the plasma is considered to result from ionization of the treatment gas. The surface of the insulating film 203 is terminated with ions (radicals) generated by the ionization. In the apparatus in FIG. 4, the distribution of magnetic field of a magnetic coil is a divergent magnetic field in which the magnetic field becomes weaker as the magnetic field comes closer to the sample chamber.

Plasma can be suitably selected from high-frequency plasma, remote plasma, and microwave plasma. The treatment gas inlet A and the treatment gas inlet B are used to introduce a treatment gas. In the present embodiment, the treatment gas is suitably selected so that both hydrogen atoms and nitrogen atoms are contained such as a gas mixture of hydrogen and nitrogen and that of nitrogen and a hydrocarbon-based gas. Gases containing hydrogen atoms or nitrogen atoms include, for example, N₂, NH₄, H₂, CH₄, C₂H₄, and C₂H₂. If a treatment gas contains hydrogen atoms and nitrogen atoms, the treatment gas may not be a gas mixture. The treatment gas may be diluted by an inert gas. With the treatment gas containing both hydrogen atoms and nitrogen atoms, the surface of the insulating film 203 is terminated with an NH group.

The sample (device) may be heated by the substrate heating heater 410. The surface of the insulating film 203 can be terminated with an NH group only by heating the device (substrate 201) in a treatment gas.

A dipole layer 207 is formed on the insulating film by the termination treatment.

Thus, an electron-emitting device according to the present embodiment can be produced by a very simple manufacturing process.

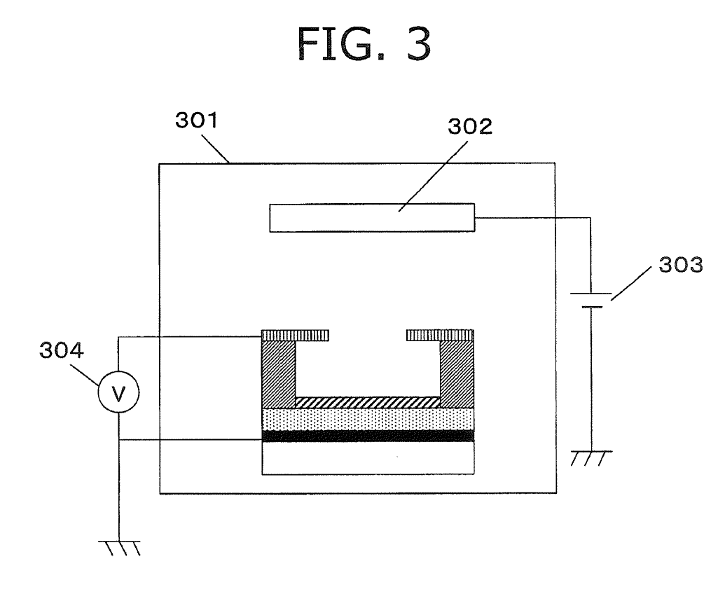

By setting the electron-emitting device produced in this manner inside a vacuum chamber 301 as shown in FIG. 3, electron emission can be observed. More specifically, electron emission can be observed by arranging an anode electrode 302 above the electron-emitting device, applying a voltage to the anode electrode by a high-voltage power supply 303, and applying a respective voltage to the gate electrode and anode electrode needed by each by a driving power supply 304. If the electron-emitting device has the configuration shown in FIG. 1, the configuration of the apparatus shown in FIG. 3 may suitably be changed such as applying a voltage between the anode electrode and cathode electrode.

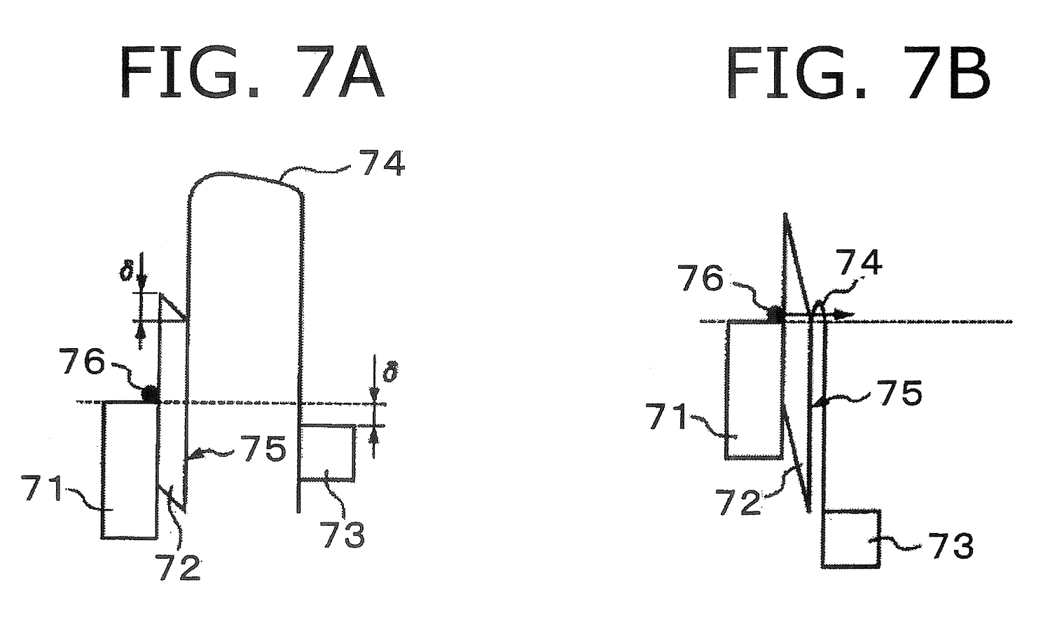

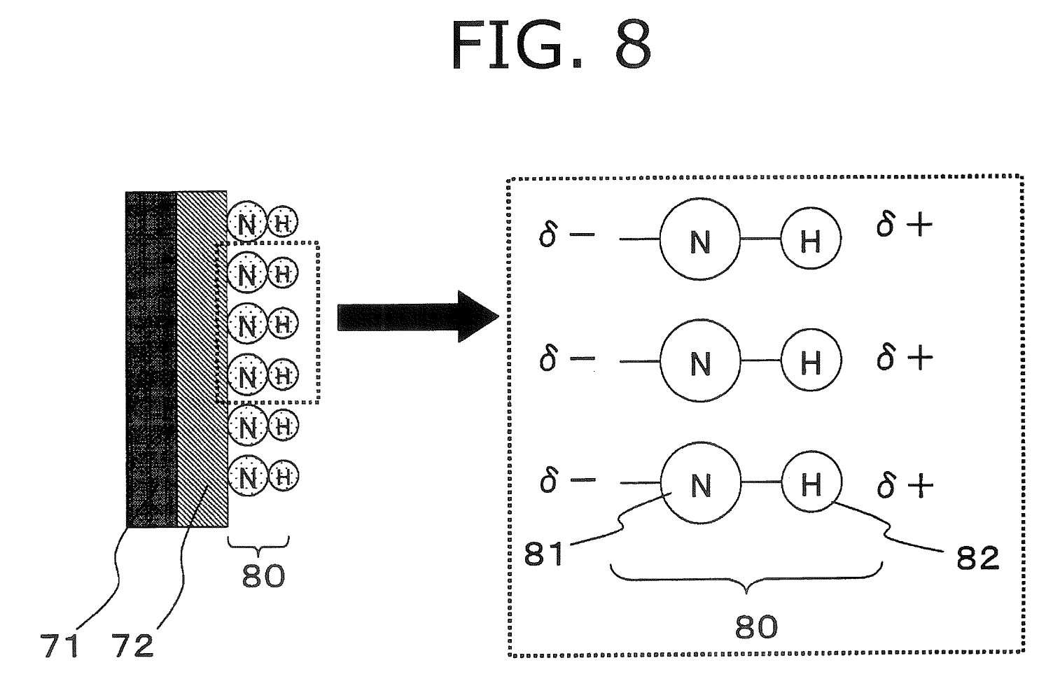

A driving principle of an electron-emitting device according to the present embodiment will be described using FIGS. 7A, 7B, and 8.

FIG. 7A is a band diagram when a driving voltage of the electron-emitting device according to the present embodiment is 0 [V] and FIG. 7B is a band diagram when the driving voltage V [V] of the electron-emitting device according to the present embodiment is applied. In FIG. 7A, an insulating film 72 is in a state in which a voltage δ is applied by polarizing by a dipole layer formed on the surface thereof. If the voltage V [V] is further applied in this state, the band of the insulating film 72 is bent still more sharply, at the same time, vacuum barrier 74 is also bent more sharply. In this state, the vacuum barrier 74 in contact with the dipole layer is higher than the conduction band on the surface of the insulating film 72 (See FIG. 7B). When this state arises, electrons 76 injected from a cathode electrode 71 are discharged into a vacuum after tunneling through the insulating film 72 and the vacuum barrier 74. The driving voltage in the electron-emitting device according to the present embodiment is preferably 50 [V] or less and more preferably 5 [V] or more and 50 [V] or less.

FIG. 8 shows a schematic diagram of a dipole layer in an electron-emitting device according to the present embodiment. In FIG. 8, reference numeral 80 is a dipole layer, reference numeral 81 is a nitrogen atom, and reference numeral 82 is a hydrogen atom. With formation of the dipole layer, the level at the surface of the insulating film 72 shows a positive electron affinity both when a driving voltage is applied between the cathode electrode 71 and electron beam induction electrodes 73 and when no driving voltage is applied. The voltage applied to the anode electrode is generally ten-odd kV to 30 kV. Thus, intensity of an electric field formed between the anode electrode and electron-emitting device is considered to be about 1×10⁵ V/cm or less. Therefore, electrons are preferably not emitted from the electron-emitting device in this intensity of the electric field. Consequently, the electron affinity on the surface of the insulating film 72 where a dipole layer is formed is preferably 2.5 eV or more in consideration of the thickness of an insulating film described later.

The thickness of the insulating film 72 can be determined by the driving voltage, and is preferably determined to be 20 nm or less and particularly preferably 10 nm or less. A lower limit of thickness of insulating film 72 may be a value so that a barrier (the insulating film 72 and a vacuum barrier) is formed to be tunneled the electrons 76 supplied from the cathode electrode 71 when the electron-emitting device is driving, but the lower limit is preferably set at 1 nm or more from the viewpoint of film formation reproducibility.

Thus, in an electron-emitting device according to the present embodiment, with the surface of the insulating film 72 always showing a positive electron affinity, a definite ratio of ON/OFF of amounts of electron emission when selected and not selected can be ensured.

In the example in FIG. 8, the dipole layer 80 is constructed by terminating the surface of the insulating film 72 with an NH group (the nitrogen atom 81 and the hydrogen atom 82). With the surface of the insulating film 72 being terminated with the NH group, the hydrogen atom is positively polarized slightly (δ+). Accordingly, the nitrogen atom 81 is negatively polarized slightly (δ−) to form the dipole layer (electric double layer) 80.

Accordingly, as shown in FIG. 7A, even if no driving voltage is applied between the cathode electrode 71 and the electron beam induction electrodes 73 in an electron-emitting device according to the present invention, a state equivalent to that in which a potential δ[V] is applied is formed on the surface of the insulating film. By applying the driving voltage V [V], as shown in FIG. 7B, the level drop at the surface of the insulating film 72 progresses and the vacuum barrier 74 is also lowered together. While the thickness of the insulating film 72 in an electron-emitting device according to the present embodiment is suitably set at a thickness that allows electrons to tunnel through the insulating film 72 by the driving voltage V [V], the thickness is preferably 10 nm or less in consideration of loads of the driving circuit and the like. If the thickness is about 10 nm, a spatial distance for the electrons 76 supplied from the cathode electrode 71 to pass through the insulating film 72 can also be shortened by applying the driving voltage V [V] and, as a result, the insulating film 72 can be made to be tunneled through.

Since, as described above, the vacuum barrier 74 is also lowered together with application of the driving voltage V [V] and also the spatial distance thereof is similarly shortened like the insulating film 72, the vacuum barrier 74 can also be made to be tunneled through. Accordingly, electron emission into a vacuum is realized.

An electron-emitting device according to the present embodiment and conventional art will be compared below.

Japanese Patent Application Laid-Open No. 2005-26209 discloses a technique to positively polarize the hydrogen atom (δ+) slightly by terminating the surface of the insulating film 72 with the hydrogen atom 82. Accordingly, atoms (for example, carbon atoms) at the surface of the insulating film 72 are negatively polarized (δ−) slightly to form the dipole layer (electric double layer) 80. In the present embodiment, a dipole generated between a nitrogen atom and a hydrogen atom, that is, a dipole whose polarization is larger than that generated between a carbon atom and a hydrogen atom is formed by terminating the surface of the insulating film 72 with two atoms of a nitrogen atom and a hydrogen atom. Thus, the band of the insulating film 72 is bent more sharply. Accordingly, the electron-emitting device becomes capable of emitting electrons at a lower driving voltage.

Japanese Patent Application Laid-Open (JP-A) No. 2002-274819 discloses an amorphous or microcrystalline carbon nitride film having an NH termination on a conductive whisker. Since the surface of the insulating film of an electron-emitting device according to the present embodiment is flat, electrons that focus can be emitted. Thus, a high-resolution image display apparatus can be provided. Moreover, semiconductor processes can be used, because the insulating film is plane, and therefore, manufacturing costs can be reduced.

<Application Examples>

Application examples of an electron-emitting device according to the present embodiment will be described below. An electron source can be constituted, for example, by arranging a plurality of electron-emitting devices according to the present embodiment on a substrate. Then, using the electron source, an image display apparatus can be constituted.

(Electron Source)

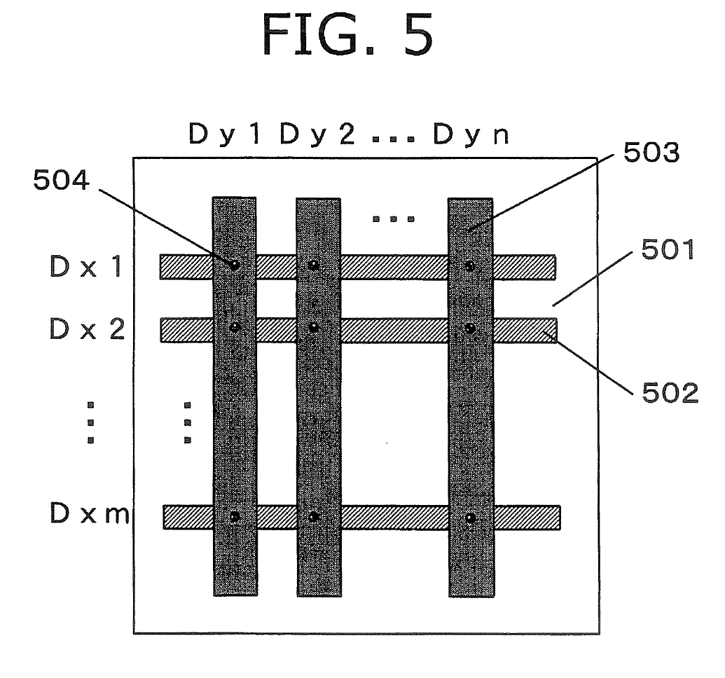

Various kinds of arrangement of electron-emitting devices are adopted. As an example, electron-emitting devices are arranged in the X direction and the Y direction in a matrix form. One side of electrodes of a plurality of electron-emitting devices arranged in the same row is commonly connected to a wiring in the X direction and the other side of electrodes of a plurality of electron-emitting devices arranged in the same column is commonly connected to a wiring in the Y direction. This is called a simple matrix arrangement. An electron source in the simple matrix arrangement will be described below using FIG. 5.

In FIG. 5, reference numeral 501 is an electron source substrate, reference numeral 502 is an X-direction wiring, and reference numeral 503 is a Y-direction wiring. Reference numeral 504 is an electron-emitting device according to the present embodiment.

M wirings Dx1, Dx2, . . . , Dxm, are the X-direction wirings 502, and can be constituted by conductive metal formed by using the vacuum evaporation method, printing method, sputtering method or the like. The material, thickness, and width of a wiring are suitably designed. N wirings Dy1, Dy2, . . . , Dyn, are the Y-direction wirings 503, and are formed in the same as the X-direction wiring 502. An interlayer insulating layer (not shown) is provided between the m X-direction wirings 502 and the n Y-direction wirings 503 to electrically separate the X-direction wirings 502 and the Y-direction wirings 503 (numbers n and m are positive integers).

The interlayer insulating layer (not shown) is constituted by SiO₂ or the like formed by using the vacuum evaporation method, printing method, sputtering method or the like. The interlayer insulating layer is formed in a desired shape all over the electron source substrate 501 forming the X-direction wirings 502 or in a portion thereof. The thickness, material, and manufacturing method of the interlayer insulating layer are suitably designed so that a potential difference in intersections of the X-direction wirings 502 and the Y-direction wirings 503 can be withstood. The X-direction wirings 502 and the Y-direction wirings 503 are each pulled out as external terminals.

The electron-emitting device 504 has a pair of electrodes (a gate electrode and a cathode electrode). In the example in FIG. 5, the gate electrode is electrically connected to one of the n Y-direction wirings 503 by a wiring made of conductive metal or the like. The cathode electrode is electrically connected to one of the m X-direction wirings 502 by a wiring made of conductive metal or the like.

A portion or all of component elements of the material constituting the X-direction wirings 502 and the Y-direction wirings 503, that constituting the wiring, and that constituting the pair of electrodes may be the same or different from one another. These materials are suitably selected, for example, from the material of the device electrodes. If the material constituting the device electrodes and wiring material are the same, a wiring connected to a device electrode can be considered as a device electrode.

A scanning signal application means (not shown) is connected to the X-direction wiring 502. The scanning signal application means applies a scanning signal to the electron-emitting device 504 connected to the selected X-direction wiring. On the other hand, a modulating signal generation means (not shown) is connected to the Y-direction wiring 503. The modulation signal generation means applies a modulation signal modulated in accordance with an input signal to each column of the electron-emitting device 504. The driving voltage applied to each electron-emitting device is supplied as a difference voltage between the scanning signal and modulation signal applied to the device.

(Image Display Apparatus)

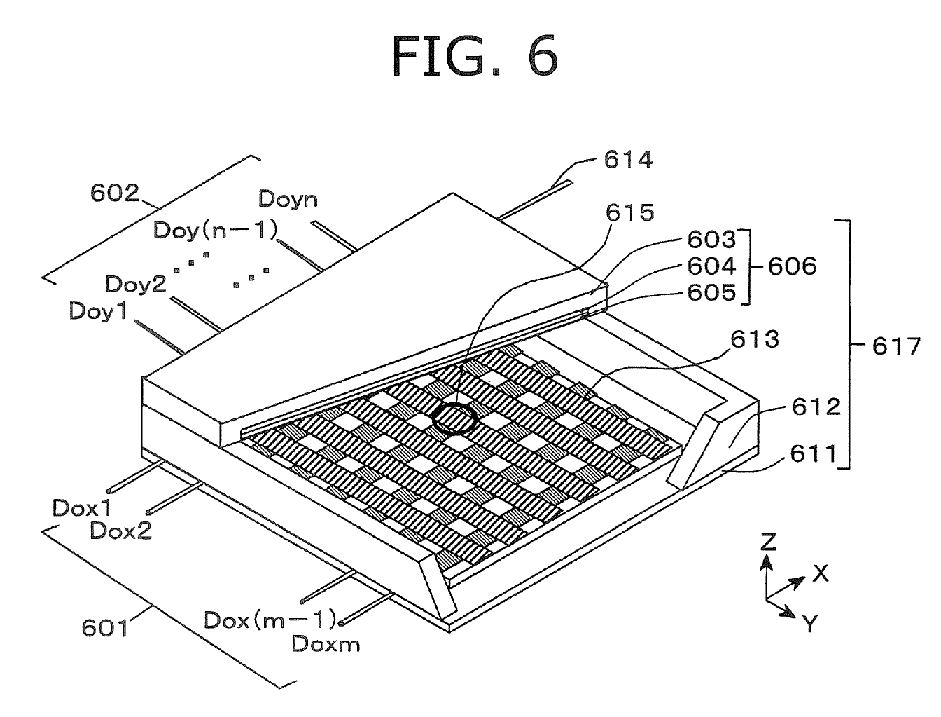

In the above constitution, individual devices are selected using a simple matrix wiring and can be driven independently. An image display apparatus constituted using the electron source will be described using FIG. 6. FIG. 6 is a schematic diagram exemplifying a display panel of the image display apparatus.

In FIG. 6, reference numeral 601 are container external terminals in the X direction, reference numeral 602 are container external terminals in the Y direction, reference numeral 613 is an electron source substrate, reference numeral 611 is a rear plate, reference numeral 606 is a face plate, and reference numeral 612 is a support frame. The electron source substrate 613 has a plurality of electron-emitting devices and the rear plate 611 is used to fix the electron source substrate 613. The face plate 606 has a phosphor film 604 and a metal back 605 formed on the surface inside a glass substrate 603 (the electron source substrate side). The phosphor film 604 is constituted by a light emitting member (image formation member; phosphor) that emits light by irradiation with electrons. The rear plate 611 and the face plate 606 are connected to the support frame 612 using frit glass or the like. An external container 617 is constituted by baking the frit glass in an atmosphere or nitrogen in the temperature range of 400 to 500° C. for 10 min or more and sealing the frit glass to the rear plate 611, the face plate 606, and the support frame 612.

In the image display apparatus, a voltage is applied to each electron-emitting devices 615 via the container external terminals Dox1 to Doxm and Doy1 to Doyn. Each of the electron-emitting devices 615 emits electrons in accordance the applied voltage.

The emitted electrons are accelerated by applying a high voltage to the metal back 605 or a transparent electrode (not shown) via a high-voltage terminal 614.

The accelerated electrons collide against the phosphor film 604 to form an image by light emission being generated.

In addition to a display apparatus of TV broadcasting and a display apparatus of a videoconference system, computer and the like, an image display apparatus according to the present embodiment can also be used as an image formation apparatus as an optical printer constituted by using a photosensitive drum or the like.

### EXAMPLES

Examples of the present invention will be described below in detail.

### Example 1

A concrete method of manufacturing an electron-emitting device in the present example will be described below in detail using FIG. 1.

(Step 1)

First, quartz (SiO₂) as the substrate 101 was adequately cleaned and a film of Pt as the cathode electrode 102 was formed to a thickness of 200 nm on the substrate 101 by the sputtering method.

(Step 2)

Next, a DLC film containing plenty of Pt particles was formed on the cathode electrode 102 as the insulating film 103 using the co-sputtering method. The thickness of the insulating film 103 was set at about 10 nm and Pt concentrations in the insulating film 103 were about 20%.

(Step 3)

Next, the surface of the insulating film 103 was terminated with an NH group using the apparatus in FIG. 4. That is, the dipole layer 104 was formed on the surface of the insulating film 103 by the step. The termination treatment was performed under the following conditions:

| | |
|---|---|
| Treatment gas | NH₃ (50 sccm) |
| Pressure | 0.25 Pa |
| ECR plasma power | 300 W |
| Treatment time | 30 sec. |

An electron-emitting device in the present example was produced by undergoing the above steps.

Electron emission characteristics of the produced electron-emitting device were measured by applying a voltage between the anode electrode and cathode electrode in the apparatus shown in FIG. 3. The anode electrode was arranged so that the anode electrode became a parallel flat plate with respect to the insulating film 103. The distance between the insulating film 103 and the anode electrode was set at 100 μm. As a result of evaluating electron emission characteristics, we could obtain an electron emission current of about 10 mA/cm² in an electric field of 55 V/μm.

### Example 2

A concrete method of manufacturing an electron-emitting device in the present example will be described below in detail using FIG. 1.

(Step 1)

First, quartz (SiO₂) as the substrate 101 was adequately cleaned and a film of Pt as the cathode electrode 102 was formed to a thickness of 200 nm on the substrate 101 by the sputtering method.

(Step 2)

Next, a DLC film containing plenty of Co particles was formed on the cathode electrode 102 as the insulating film 103 using the co-sputtering method. The thickness of the insulating film 103 was set at about 10 nm and Co concentrations in the insulating film 103 were about 20%.

(Step 3)

Next, the surface of the insulating film 103 was terminated with an NH group using the apparatus in FIG. 4. That is, the dipole layer 104 was formed on the surface of the insulating film 103 by the step. The termination treatment was performed under the following conditions:

| | |
|---|---|
| Treatment gas | NH₃ (20 sccm) |
| | H₂ (30 sccm) |
| Pressure | 0.25 Pa |
| ECR plasma power | 400 W |
| Treatment time | 30 sec. |

An electron-emitting device in the present example was produced by undergoing the above steps.

Electron emission characteristics of the produced electron-emitting device were measured by applying a voltage between the anode electrode and cathode electrode in the apparatus shown in FIG. 3. The anode electrode was arranged so that the anode electrode became a parallel flat plate with respect to the insulating film 103. The distance between the insulating film 103 and the anode electrode was set at 100 μm. As a result of evaluating electron emission characteristics, we could obtain an electron emission current of about 10 mA/cm² in an electric field of 55 V/μu.

### Example 3

A concrete method of manufacturing an electron-emitting device in the present example will be described below in detail using FIG. 1.

(Step 1)

First, quartz (SiO₂) as the substrate 101 was adequately cleaned and a film of Pt as the cathode electrode 102 was formed to a thickness of 200 nm on the substrate 101 by the sputtering method.

(Step 2)

Next, a DLC film was formed on the cathode electrode 102 using the filament CVD method. Then, Co particles of 1 atm % were implanted into the DLC film using an ion-implantation technique. The insulating film 103 was produced by the step. The thickness of the insulating film 103 was set at about 10 nm.

(Step 3)

Next, the surface of the insulating film 103 was terminated with an NH group using the apparatus in FIG. 4. That is, the dipole layer 104 was formed on the surface of the insulating film 103 by the step. The termination treatment was performed under the following conditions:

| | |
|---|---|
| Treatment gas | CH₄ (30 sccm) |
| | NH₃ (20 sccm) |
| Pressure | 0.25 Pa |
| ECR plasma power | 300 W |
| Treatment time | 20 sec. |

An electron-emitting device in the present example was produced by undergoing the above steps.

Electron emission characteristics of the produced electron-emitting device were measured by applying a voltage between the anode electrode and cathode electrode in the apparatus shown in FIG. 3. The anode electrode was arranged so that the anode electrode became a parallel flat plate with respect to the insulating film 103. The distance between the insulating film 103 and the anode electrode was set at 100 μm. As a result of evaluating electron emission characteristics, we could obtain an electron emission current of about 12 mA/cm² in an electric field of 40 V/μm.

### Example 4

A concrete method of manufacturing an electron-emitting device in the present example will be described below in detail using FIG. 2.

(Step 1)

First, quartz (SiO₂) as the substrate 201 was adequately cleaned and a film of Pt as the cathode electrode 202 was formed to a thickness of 200 nm on the substrate 201 by the sputtering method.

(Step 2)

Next, a DLC film containing plenty of Co particles was formed on the cathode electrode 202 as the insulating film 203 using the co-sputtering method. The thickness of the insulating film 203 was set at about 10 nm and Co concentrations in the insulating film 203 were about 25%.

(Step 3)

Next, a film of SiO₂ as the insulating layer 204 was formed to a thickness of about 1,000 nm on the insulating film 203 by the plasma CVD method using SiH₄ and N₂O as material gases.

(Step 4)

Next, a film of Pt as the gate electrode 205 was formed to a thickness of 100 nm on the insulating layer 204 by the sputtering method.

(Step 5)

Next, a positive type photo resist (OFPR5000/manufactured by Tokyo Ohka Kogyo Co., Ltd.) was spin-coated by the photolithography method and a photo-mask pattern was exposed and developed to form the mask pattern 206 of resist having an opening of 5 μm in diameter.

(Step 6)

Next, a portion of the gate electrode 205 and a portion of the insulating layer 204 were removed by dry etching. Removal of a portion of the gate electrode 205 (Pt) was carried out under conditions of an Ar gas as an etching gas, 200 W of etching power, and 1 Pa of etching pressure. Removal of a portion of the insulating layer 204 was carried out under conditions of a gas mixture of CF₄ and H₂ as an etching gas, 150 W of etching power, and 1.5 Pa of etching pressure. The gate electrode corresponding to the position of the opening of the resist was removed by the present step. The insulating layer 204 was etched until the thickness thereof was almost halved. Like the gate electrode 205, only the insulating layer 204 corresponding to the position of the opening of the resist was removed.

(Step 7)

Next, a remaining mask pattern was removed by a peeling liquid (peeling liquid 104/manufactured by Tokyo Ohka Kogyo Co., Ltd.). Then, a portion of the insulating layer 204 was further removed by soaking the insulating layer 204 (SiO₂) in BHF. After the wet etching, the device was cleaned with water for 10 minutes. An opening of the gate electrode and insulating layer was formed at the position of the opening of the resist by the present step. Also, the insulating film 203 was exposed in the opening by the present step.

(Step 8)

Next, the surface of the insulating film 203 was terminated with an NH group using the apparatus in FIG. 4. That is, a dipole layer was formed on the surface of the insulating film 203 by the step. The termination treatment was performed under the following conditions:

| | |
|---|---|
| Treatment gas | CH₄ (50 sccm) |
| | H₂ (10 sccm) |
| | NH₃ (10 sccm) |
| Pressure | 0.25 Pa |
| ECR plasma power | 200 W |
| Treatment time | 30 sec. |

An electron-emitting device in the present example was produced by undergoing the above steps.

The electron-emitting device produced in the present example was arranged in a vacuum chamber, as shown in FIG. 3, and an anode electrode of phosphor was set above the device. A DC voltage of 5 kv was applied to the anode electrode and a pulse voltage of 10 V was applied between the cathode electrode and gate electrode. As a result thereof, electron emission was observed in synchronization with the pulse signal. That is, the electron-emitting device in the present example is superior in responsiveness. It is suggested that a similar effect can be achieved by applying the present electron-emitting device as an electron source.

### Example 5

An image display apparatus using the electron-emitting device in Example 4 was provided. As shown in FIG. 5, the cathode electrode was connected to the X-direction wiring. The gate electrode 205 was connected to the Y-direction wiring. Electron-emitting devices for 300×200 pixels were arranged with 144 openings as a pixel, 30-μm horizontal and 30-μm vertical pitches. A phosphor was arranged above each electron-emitting device. The distance between the phosphor and electron-emitting device was set at about 1 mm. Phosphors were arranged in a one-to-one relationship with electron-emitting devices. A voltage of 5 kV was applied to the phosphor. When a pulse signal of 18 V was input as an input signal, a high-definition image was displayed.

The present invention can provide, as described above, an electron-emitting device capable of emitting electrons at a low threshold. Further, the present invention can provide an electron-emitting device capable of emitting electrons at a low voltage with a high degree of efficiency and whose manufacturing process is easy. Moreover, an electron source and an image display apparatus superior in performance can be realized by applying an electron-emitting device of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-323177, filed on Dec. 14, 2007, which is thereby incorporated by reference herein in its entirety.

What is claimed is:

1. An electron-emitting device, comprising:
a cathode electrode;
an insulating film provided on the cathode electrode; and
a dipole layer provided on the insulating film, wherein
the dipole layer is formed by terminating the insulating film with an NH group.

2. An electron-emitting device according to claim 1, wherein
the insulating film has a thickness of 10 nm or less.

3. An electron-emitting device according to claim 1, wherein
a surface of the insulating film has a positive electron affinity.

4. An electron-emitting device according to claim 1, wherein
the insulating film is constituted by material having carbon as a main component.

5. An electron-emitting device, comprising:
a cathode electrode; and
an insulating film provided on the cathode electrode and formed from material having carbon as a main component, wherein
a surface of the insulating film is terminated with an NH group.

6. An electron-emitting device according to claim 4, wherein
the material having carbon as a main component contains sp³ carbon.

7. An electron-emitting device according to claim 1, wherein
roughness of a surface of the insulating film is smaller than 1/10 of a thickness of the insulating film in RMS notation.

8. An electron-emitting device according to claim 1, wherein
roughness of a surface of the cathode electrode is smaller than 1/10 of a thickness of the cathode electrode in RMS notation.

9. An electron-emitting device according to claim 8, wherein
the roughness of the surface of the cathode electrode is 1 nm or less in RMS notation.

10. An electron-emitting device according to claim 1, wherein
the cathode electrode is provided on a substrate, and
roughness of a surface of the substrate is smaller than 1/10 of a thickness of the substrate in RMS notation.

11. An electron-emitting device according to claim 10, wherein
a surface of the cathode electrode and the surface of the substrate are parallel to each other.

12. An electron-emitting device according to claim 1, wherein
the insulating film contains a plurality of conductive particles.

13. An electron source, comprising:
a plurality of the electron-emitting devices according to claim 1.

14. An image display apparatus comprising:
the electron source according to claim 13; and
a light emitting member that emits light by irradiation with electrons.
